(19) United States
(12) Patent Application Publication
(10) Pub. No.: US 2014/0138137 A1
(43) Pub. Date: May 22, 2014

(54) ARRAY TYPE MULTILAYER CERAMIC ELECTRONIC COMPONENT, MOUNTING STRUCTURE OF CIRCUIT BOARD HAVING ARRAY TYPE MULTILAYER CERAMIC ELECTRONIC COMPONENT MOUNTED THEREON, AND METHOD OF MANUFACTURING THE SAME

(71) Applicant: SAMSUNG ELECTRO-MECHANICS CO., LTD., Suwon (KR)

(72) Inventor: Joon Hwan KWAG, Suwon (KR)

(73) Assignee: SAMSUNG ELECTRO-MECHANICS CO., LTD., Suwon (KR)

(21) Appl. No.: 13/785,914

(22) Filed: Mar. 5, 2013

(30) Foreign Application Priority Data
Nov. 21, 2012 (KR) 10-2012-0132552

(51) Int. Cl. H01G 4/30

(52) U.S. Cl. CPC H01G 4/30
USPC 174/260; 361/301.4; 156/89.12

(57) ABSTRACT

There is provided an array type multilayer ceramic electronic component, including: a ceramic element having a plurality of dielectric layers laminated therein; first and second external electrodes spaced apart from each other in a length direction on one surface and the other surface opposing the one surface of the ceramic element; and a plurality of internal electrode laminated parts including a plurality of first and second internal electrodes opposing each other within the ceramic element and connected to the first and second external electrodes, wherein a portion of the internal electrode laminated parts is different from other internal electrode laminated parts thereof in terms of the number of laminations of the first and second internal electrodes.

### CROSS-REFERENCE TO RELATED APPLICATIONS

This application claims the priority of Korean Patent Application No. 10-2012-0132552 filed on Nov. 21, 2012, in the Korean Intellectual Property Office, the disclosure of which is incorporated herein by reference.

### BACKGROUND OF THE INVENTION

1. Field of the Invention

The present invention relates to an array type multilayer ceramic electronic component, amounting structure of a circuit board having the array type multilayer ceramic electronic component mounted thereon, and a method of manufacturing the same.

2. Description of the Related Art

Capacitors, inductors, piezoelectric elements, varistors, thermistors, and the like, are representative electronic components using a ceramic material.

Among these ceramic electronic components, a multilayer ceramic capacitor (MLCC) has advantages in that it has a small size, has high capacitance secured therein, and has ease of mountability.

This multilayer ceramic capacitor is a chip type condenser that is mounted on the circuit boards of several different electronic products, such as an image device including a liquid crystal display (LCD), a plasma display panel (PDP), or the like, a computer, a personal digital assistant (PDA), a cellular phone, and the like, to thereby perform electrical charging and discharging.

This multilayer ceramic capacitor is manufactured by alternately laminating a plurality of dielectric layers and internal electrodes to forma laminate, sintering the laminate, and forming external electrodes thereon. Generally, the number of laminated internal electrodes determines the capacitance of a product.

As electronic products have recently been miniaturized, multilayer ceramic capacitors used for the electronic products have also been required to have an ultra-small size and an ultra-high capacitance.

The multilayer ceramic capacitor is required to have a predetermined area so as to be mounted on a printed circuit board.

In addition, in the case in which a plurality of multilayer ceramic capacitors are mounted on a single printed circuit board, the respective multilayer ceramic capacitors needs to secure a predetermined space therebetween for the proper operation thereof.

However, when electronic products become thinner and smaller, there may be a limitation on the space in which the multilayer ceramic capacitor may be mounted, and thus, it may be difficult to design the products. That is, in the case in which a plurality of multilayer ceramic capacitors having different characteristics such as capacitance or the like are mounted at the same time, there is a limitation in downsizing the electronic products.

Related Art Documents 1 and 2 below are directed to array type multilayer ceramic electronic components, but do not disclose that internal electrode laminated parts have different numbers of laminated internal electrodes.

### RELATED ART DOCUMENTS

### Patent Documents

(Patent Document 1) Korean Patent Laid-Open Publication No. 10-2005-0044083
(Patent Document 2) Korean Patent Laid-Open Publication No. 10-2012-0056548

### SUMMARY OF THE INVENTION

An aspect of the present invention provides a method of significantly reducing the area of a mounting board, required for mounting a plurality of multilayer ceramic electronic components, thus decreasing a size of the mounting board when the plurality of multilayer ceramic electronic components having various electrical characteristics are mounted on a single mounting board.

According to an aspect of the present invention, there is provided an array type multilayer ceramic electronic component, including: a ceramic element having a plurality of dielectric layers laminated therein; first and second external electrodes spaced apart from each other in a length direction on one surface and the other surface opposing the one surface of the ceramic element; and a plurality of internal electrode laminated parts including a plurality of first and second internal electrodes opposing each other within the ceramic element and connected to the first and second external electrodes, wherein a portion of the internal electrode laminated parts is different from other internal electrode laminated parts thereof in terms of the number of laminations of the first and second internal electrodes.

Here, all of the internal electrode laminated parts may be different in terms of the number of laminations of the first and second internal electrodes.

The first and second external electrodes may be extended in a direction in which the first and second internal electrodes are laminated.

The first and second external electrodes may be extended to portions of upper and lower surfaces of the ceramic element.

The first and second external electrodes may be disposed to oppose each other.

The first and second internal electrodes may be led out in opposite directions such that the first and second internal electrodes are alternately connected to the first and second external electrodes.

The first and second internal electrodes may include capacitance forming portions overlapped with each other with the dielectric layers interposed therebetween to thereby contribute to capacitance formation, and lead out portions extended from the capacitance forming portions to the one surface or the other surface of the ceramic element and respectively connected to the first and second external electrodes.

According to another aspect of the present invention, there is provided a mounting structure of a circuit board having an array type multilayer ceramic electronic component mounted thereon, the mounting structure including: a printed circuit board having a plurality of first and second electrode pads spaced apart from each other in a length direction on an upper surface thereof; and an array type multilayer ceramic capacitor mounted on the printed circuit board, the array type multilayer ceramic electronic component including: a ceramic element having a plurality of dielectric layers laminated therein; first and second external electrodes spaced apart from each other in a length direction on one surface and the other surface opposing the one surface of the ceramic element and connected to the plurality of first and second electrode pads, respectively; and a plurality of internal electrode laminated parts including a plurality of first and second internal electrodes opposing each other within the ceramic element and connected to the first and second external electrodes, wherein a portion of the internal electrode laminated parts is different from other internal electrode laminated parts thereof in terms of the number of laminations of the first and second internal electrodes.

According to another aspect of the present invention, there is provided a method of manufacturing an array type multilayer ceramic electronic component, the method including: forming a plurality of first and second internal electrodes on ceramic sheets, the first and second internal electrodes being exposed through one surface or the other surface opposing the one surface of the ceramic sheets and spaced apart from each other in a length direction; forming a laminate having a plurality of internal electrode laminated parts spaced apart from each other in the length direction by laminating the plurality of ceramic sheets on which the plurality of first and second internal electrodes are formed; forming a ceramic element by firing the laminate; and forming a plurality of first and second external electrodes to be spaced apart from each other in the length direction on both surfaces of the ceramic element, in order to cover exposed portions of the respective internal electrode laminated parts, wherein in the forming of the internal electrodes, the number of internal electrodes spaced apart from each other in the length direction on the ceramic sheets disposed above and below is controlled such that the respective internal electrode laminated parts have different numbers of laminations of internal electrodes.

Here, in the forming of the external electrodes, the first and second external electrodes may be extended in a direction in which the first and second internal electrodes are laminated on the both surfaces of the ceramic element.

Here, in the forming of the external electrodes, the first and second external electrodes may be extended to portions of upper and lower surfaces of the ceramic element.

Here, in the forming of the external electrodes, the first and second external electrodes may be disposed to oppose each other on both surfaces of the ceramic element.

Here, in the forming of the internal electrodes, the first and second internal electrodes may be led out in opposite directions such that the first and second internal electrodes are alternately connected to the first and second external electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective view showing a schematic structure of an array type multilayer ceramic capacitor according to an embodiment of the present invention;

FIG. 2 is a perspective view showing a ceramic element of FIG. 1 from which external electrodes are removed;

FIG. 3 is an exploded perspective view showing a structure in which dielectric layers and internal electrodes of FIG. 1 are formed;

FIG. 4 is a perspective view showing a state in which the array type multilayer ceramic capacitor of FIG. 1 is mounted on a printed circuit board; and

FIG. 5 is a plane view of FIG. 4.

### DETAILED DESCRIPTION OF THE EMBODIMENTS

Hereinafter, embodiments of the present invention will be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like elements.

The present invention is directed to a ceramic electronic component, and the ceramic electronic component according to an embodiment of the present invention may be a multilayer ceramic capacitor, an inductor, a piezoelectric element, a varistor, a chip resistor, a thermistor, or the like. The multilayer ceramic capacitor will be described as one example of the ceramic electronic product as follows.

In addition, in the present embodiments, for the convenience of explanation, left and right surfaces of a ceramic element on which first and second external electrodes are formed are defined as both surfaces of the ceramic element, and surfaces vertically crossing the both surfaces are defined as left and right end surfaces.

Array Type Multilayer Ceramic Capacitor

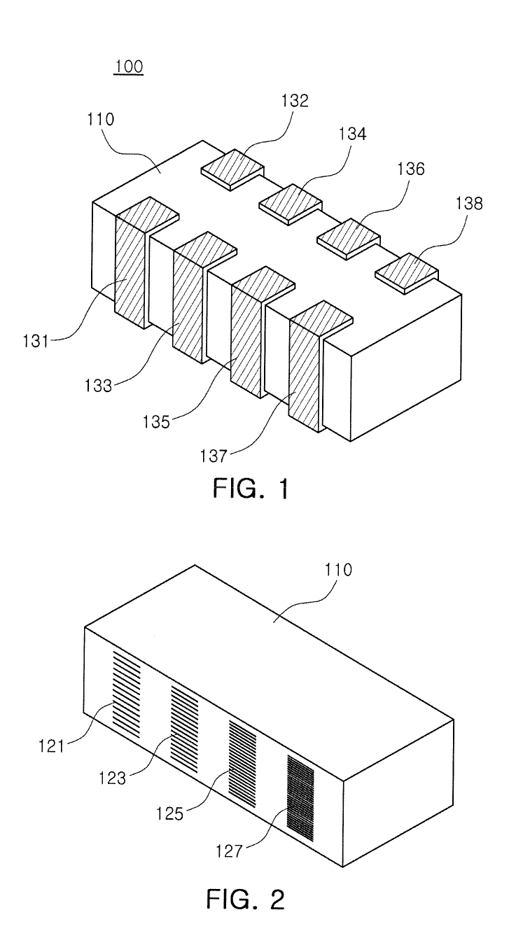

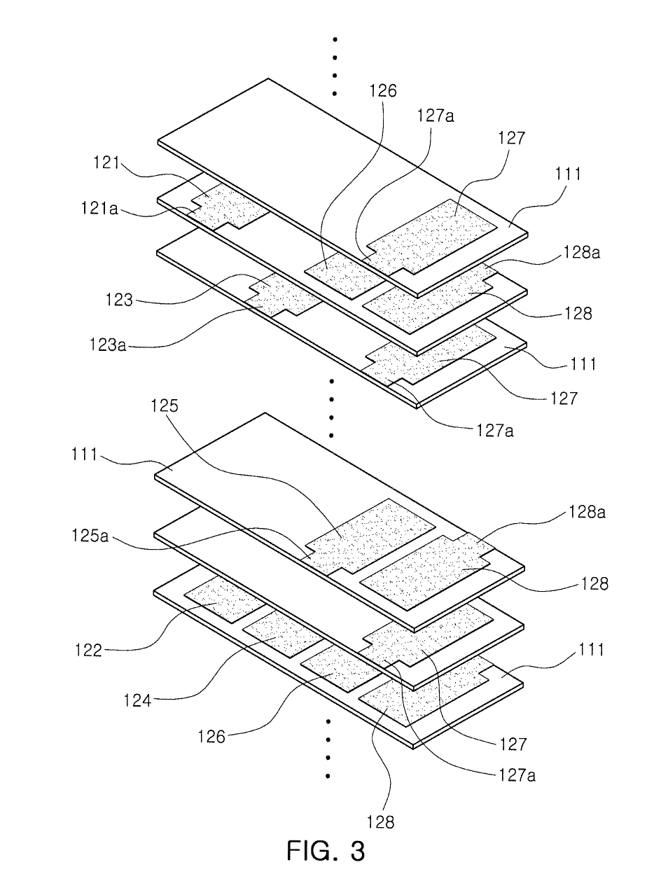

Referring to FIGS. 1 to 3, an array type multilayer ceramic capacitor 100 may include: a ceramic element 110 having a plurality of dielectric layers 111 laminated therein; a plurality of first external electrodes 131, 133, 135, and 137 and second external electrodes 132, 134, 136, and 138 spaced apart from each other in a length direction on one surface and the other surface opposing one surface of the ceramic element; and a plurality of internal electrode laminated parts including a plurality of first internal electrodes 121, 123, 125, and 127 and second internal electrodes 122, 124, 126, and 128, formed to oppose each other within the ceramic element 110.

In the present embodiment, four internal electrode laminated parts are shown to be spaced apart from each other in the length direction of the ceramic element 110, but the present invention is not limited thereto. For example, the number of internal electrode laminated parts may be properly changed to 2, 3, or 5 or greater, as necessary.

In addition, the plurality of internal electrode laminated parts may be different from each other in terms of the number of laminations of first internal electrodes 121, 123, 125, and 127 and second internal electrodes 122, 124, 126, and 128.

In the present embodiment, all internal electrode laminated parts may be different from each other in terms of the number of laminations of internal electrodes, but the present invention is not limited thereto. For example, as necessary, portions of the internal electrode laminated parts may be the same as each other in terms of the number of laminations of internal electrodes.

The ceramic element 110 may be formed by laminating the plurality of dielectric layers 111 and then performing firing thereon.

Here, the plurality of dielectric layers 111 constituting the ceramic element 110 may be in a sintered state, and may be integrated such that a boundary between adjacent dielectric layers 111 may not be readily apparent.

In addition, the ceramic element 110 is not particularly limited in terms of the shape thereof, and may generally have a rectangular parallelepiped shape, but the present invention is not limited thereto.

In addition, the dimension of the ceramic element 110 is not particularly limited. For example, the ceramic element 110 may be formed in a size of 0.6 mm×0.3 mm or the like, and thereby constitute the multilayer ceramic capacitor 100 having a high capacitance of 1.0 μF or higher.

The dielectric layers 111 contribute to capacitance formation of the capacitor, and the thickness of each dielectric layer 111 may be optionally changed according to the design of capacitance of the multilayer ceramic capacitor.

The dielectric layers 111 constituting the ceramic element 110 may include a ceramic material having a high dielectric constant, for example, a barium titanate (BaTiO₃) based ceramic powder, and a binder.

The barium titanate (BaTiO₃) based ceramic powder may be (Ba₁₋ₓCaₓ)TiO₃, Ba(Ti_{1-y}Ca_{y})O₃, (Ba₁₋ₓCaₓ) (Ti_{1-y}Zr_{y})O₃, Ba(Ti_{1-y}Zr_{y})O₃, or the like, in which calcium (Ca), zirconium (Zr), or the like is dissolved in barium titanate (BaTiO₃), but the present invention is not particularly limited thereto.

In addition, as necessary, various ceramic additives such as transition metal oxides or carbides, rare earth elements, magnesium (Mg) or aluminum (Al), and the like, an organic solvent, a plasticizer, a binder, a dispersant, and the like may be further added to the dielectric layers 111.

The first internal electrodes 121, 123, 125, and 127 and the second internal electrodes 122, 124, 126, and 128 are formed on ceramic sheets for forming the dielectric layers 111 to be stacked. Then, the first internal electrodes 121, 123, 125, and 127 and the second internal electrodes 122, 124, 126, and 128 may be appropriately arranged with at least one dielectric layer 111 interposed therebetween within the ceramic element 110, depending on the amount of laminated internal electrodes of the internal electrode laminated parts.

In the present embodiment, a first internal electrode laminated part having the greatest amount of laminated internal electrodes may be formed by alternately laminating the first and second internal electrodes 127 and 128 with one dielectric layer 111 interposed therebetween.

In addition, a second internal electrode laminated part having the second greatest amount of laminated internal electrodes may be configured by repeatedly performing operations of forming the second internal electrode 126, disposing two dielectric layers 111 on the second internal electrode 126 and forming the first internal electrode 125 thereon, and then disposing two dielectric layers 111 on the first internal electrode 125 and forming the second internal electrode 126 thereon, again.

In addition, a third internal electrode laminated part having the third greatest amount of laminated internal electrodes may be configured by repeatedly performing operations of forming the second internal electrode 124, disposing three dielectric layers 111 on the second internal electrode 124 and forming the first internal electrode 123 thereon, and then disposing three dielectric layers 111 on the first internal electrode 123 and forming the second internal electrode 124 thereon, again.

In addition, a fourth internal electrode laminated part having the smallest amount of laminated internal electrodes may be configured by repeatedly performing operations of forming the second internal electrode 122, disposing four dielectric layers 111 on the second internal electrode 122 and forming the first internal electrode 121 thereon, and then disposing four dielectric layers 111 on the first internal electrode 121 and forming the second internal electrode 122 thereon, again.

As described above, the amount of dielectric layers 111 interposed between the internal electrodes formed in each of the internal electrode laminated parts may be controlled, to thereby provide the array type multilayer ceramic electronic component 100 having a plurality of internal electrode laminated parts contained in a single ceramic element 110, the plurality of internal electrode laminated parts being different from each other in terms of the number of laminations of internal electrodes, that is, electrical characteristics and capacitance.

Each of the first internal electrodes 121, 123, 125, and 127 and the second internal electrodes 122, 124, 126, and 128 may be formed by printing a conductive paste on one surface of the dielectric layer 111 at a predetermined thickness.

Here, the conductive paste may be printed by a screen printing method, a gravure printing method, or the like, but the present invention is not limited thereto.

In addition, the first internal electrodes 121, 123, 125, and 127 and the second internal electrodes 122, 124, 126, and 128 are pairs of electrodes having different polarities, and may be arranged to oppose each other in a direction in which the dielectric layers 111 are laminated.

In addition, the first internal electrodes 121, 123, 125, and 127 and the second internal electrodes 122, 124, 126, and 128 may be led out in opposite directions such that they are alternately connected to the first external electrodes 131, 133, 135, and 137 and the second external electrodes 132, 134, 136, and 138, respectively, and may be electrically insulated from each other due to at least one dielectric layer 111 interposed therebetween.

In addition, the first internal electrodes 121, 123, 125, and 127 and the second internal electrodes 122, 124, 126, and 128 may include capacitance forming portions and lead out portions 121a, 123a, 125a, 127a, 122a, 124a, 126a, and 128a, respectively. Here, the capacitance forming portions are overlapped with each other in a thickness direction, with the dielectric layer 111 interposed therebetween, to thereby contribute to capacitance formation. The lead out portions 121a, 123a, 125a, 127a, 122a, 124a, 126a, and 128a are extended from the capacitance forming portions and are not overlapped with each other in adjacent internal electrodes.

Here, the lead out portions 121a, 123a, 125a, 127a, 122a, 124a, 126a, and 128a do not contribute to capacitance formation. However, the lead out portions 121a, 123a, 125a, 127a, 122a, 124a, 126a, and 128a are exposed to one surface and the other surface of the ceramic element 110 and coming into contact with the first external electrodes 131, 133, 135, and 137 and the second external electrodes 132, 134, 136, and 138 to be electrically connected therewith.

In the present embodiment, the lead out portions 121a, 123a, 125a, 127a, 122a, 124a, 126a, and 128a of the first internal electrodes 121, 123, 125, and 127 and the second internal electrodes 122, 124, 126, and 128 may be alternately exposed through the both surfaces of the ceramic element 110.

The lead out portions 121a, 123a, 125a, 127a, 122a, 124a, 126a, and 128a of the first internal electrodes 121, 123, 125, and 127 and the second internal electrodes 122, 124, 126, and 128, that are exposed through the both surfaces of the ceramic element 110 may come into contact with the first external electrodes 131, 133, 135, and 137 and the second external electrodes 132, 134, 136, and 138.

Therefore, when a predetermined voltage is applied to the first external electrodes 131, 133, 135, and 137 and the second external electrodes 132, 134, 136, and 138, charges are stored between the first internal electrodes 121, 123, 125, and 127 and the second internal electrodes 122, 124, 126, and 128, opposing each other.

Here, capacitance in the array type multilayer ceramic capacitor 100 is different depending on the first, second, third, or fourth internal electrode laminated part, and the capacitance of each internal electrode laminated part is proportional to the area of the capacitance forming portion of each of the first internal electrodes 121, 123, 125, and 127 and the second internal electrodes 122, 124, 126, and 128, which are laminated.

The first external electrodes 131, 133, 135, and 137 and the second external electrodes 132, 134, 136, and 138 may be formed of a conductive paste containing a conductive metal.

The conductive metal may be nickel (Ni), copper (Cu), palladium (Pd), gold (Au), or an alloy thereof, but the present invention is not limited thereto.

Here, the first external electrodes 131, 133, 135, and 137 and the second external electrodes 132, 134, 136, and 138 may be extended from one surface and the other surface of the ceramic element 110 in the direction in which the internal electrodes are laminated.

In addition, the first external electrodes 131, 133, 135, and 137 and the second external electrodes 132, 134, 136, and 138 may be extended to portions of upper and lower surfaces of the ceramic element 110 and may be formed in a “E” shape.

Here, the first external electrodes 131, 133, 135, and 137 and the second external electrodes 132, 134, 136, and 138 may be disposed to oppose each other in pairs.

Hereinafter, a method of manufacturing the array type multilayer ceramic capacitor 100 according to an embodiment of the present invention will be described.

First, a plurality of ceramic sheets are prepared.

The ceramic sheets are provided to form the dielectric layers 111 of the ceramic element 110 and may be formed by mixing a ceramic powder, a binder, and a solvent to prepare a slurry and forming the slurry into sheets each having a thickness of several micrometers (μm) through a doctor blade method or the like.

The ceramic powder may contain a barium titanate (BaTiO₃) based material.

However, the present invention is not limited thereto, and may include (Ba₁₋ₓCaₓ)TiO₃, Ba(Ti_{1-y}Ca_{y})O₃, (Ba₁₋ₓCaₓ)(Ti_{1-y})Zr_{y})O₃, or Ba(Ti_{1-y}Zr_{y})O₃, in which Ca, Zr, or the like is dissolved in BaTiO₃.

In addition, the slurry may be prepared by blending a ceramic additive, an organic solvent, a plasticizer, a binder, and a dispersant into the ceramic powder material, using a basket mill.

Then, the plurality of first internal electrodes 121, 123, 125, and 127 and second internal electrodes 122, 124, 126, and 128 are formed in a length direction of the ceramic sheets by printing a conductive paste on respective one surfaces of the ceramic sheets.

Here, the first internal electrodes 121, 123, 125, and 127 may be exposed through one surface of the ceramic sheets and the second internal electrodes 122, 124, 126, and 128 may be exposed through the other surface of the ceramic sheet, opposing the one surface of the ceramic sheets in an opposite direction to that of the first internal electrodes 121, 123, 125, and 127.

That is, the first internal electrodes 121, 123, 125, and 127 and the second internal electrodes 122, 124, 126, and 128 may be led out in opposite directions such that they are alternately connected to the first external electrodes 131, 133, 135, and 137 and the second external electrodes 132, 134, 136, and 138.

Here, the first internal electrodes 121, 123, 125, and 127 and the second internal electrodes 122, 124, 126, and 128 may be formed such that the number of internal electrodes spaced apart from each other in the length direction on the ceramic sheets disposed above and below is controlled in order to allow the respective internal electrode laminated parts to have different numbers of internal electrodes.

The conductive paste may be printed by screen printing, gravure printing, or the like. The conductive paste may include a metal powder, a ceramic powder, a silica (SiO₂) powder, or the like.

In addition, the metal powder may be at least one of a noble metal material such as silver (Ag), lead (Pb), platinum, or the like, nickel (Ni), manganese (Mn), chrome (Cr), cobalt (Co), aluminum (Al), and copper (Cu), or an alloy thereof.

Then, the plurality of ceramic sheets on which the internal electrodes are formed are laminated, and then pressed in the lamination direction, such that the ceramic sheets, the first internal electrodes 121, 123, 125, and 127, and the second internal electrodes 122, 124, 126, and 128 are compressed to form a laminate having a plurality of internal electrode laminate parts spaced apart from each other in the length direction.

Then, the laminate is cut for each region corresponding to one array type multilayer ceramic capacitor, thereby forming each chip.

Here, the cutting may be carried out such that respective one ends of the first internal electrodes 121, 123, 125, and 127 and respective one ends of the second internal electrodes 122, 124, 126, and 128 may be alternately exposed through both surfaces of the laminate.

Thereafter, the cut chip is plasticized and fired at a high temperature, and then polished, thereby completing the ceramic element 110 having the plurality of first internal electrodes 121, 123, 125, and 127 and second internal electrodes 122, 124, 126, and 128.

Then, first external electrodes 131, 133, 135, and 137 and second external electrodes 132, 134, 136, and 138 are formed on the both surfaces of the ceramic element 110 such that they cover the exposed portions of the respective internal electrode laminated parts to be electrically connected to the first internal electrodes 121, 123, 125, and 127 and the second external electrodes 122, 124, 126, and 128, respectively.

Here, the first external electrodes 131, 133, 135, and 137 and the second external electrodes 132, 134, 136, and 138 are disposed to oppose each other on the both surfaces of the ceramic element 110, and may be extended in the lamination direction of the internal electrodes.

In addition, the first external electrodes 131, 133, 135, and 137 and the second external electrodes 132, 134, 136, and 138 may be extended to portions of upper and lower surfaces of the ceramic element 110 and may be formed in a “c” shape.

Mounting Structure of Circuit Board Having Thereon Multilayer Ceramic Capacitor

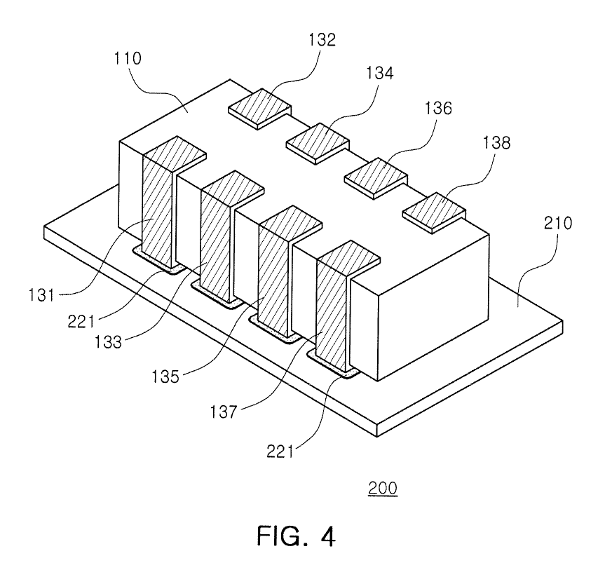

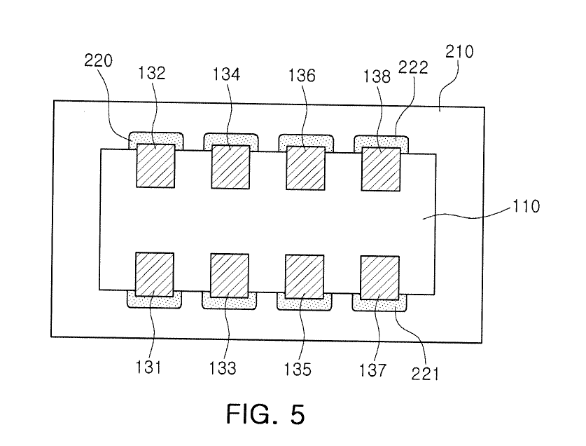

Referring to FIGS. 4 and 5, a mounting board 200 having thereon the array type multilayer ceramic capacitor 100 according to the present embodiment may include a printed circuit board 210 on which the array type multilayer ceramic capacitor 100 is horizontally mounted; and a plurality of first and second electrode pads 221 and 222 spaced apart from each other along a length direction of the printed circuit board on an upper surface of the printed circuit board 210.

Here, in the array type multilayer ceramic capacitor 100, the first external electrodes 131, 133, 135, and 137 and the second external electrodes 132, 134, 136, and 138 may be electrically connected to the printed circuit board 210 by soldering 230 (not shown) while they are positioned in contact with corresponding first and second electrode pads 221 and 222, respectively.

As described above, when the array type multilayer ceramic capacitor 100 having the internal electrode laminated parts with different numbers of laminations is mounted on the printed circuit board 210, a distance between the electrode pads 221 and 222 is further increased as compared with when the multilayer ceramic capacitors having electric characteristics are separately mounted on the printed circuit board 210, thereby reducing the area occupied at the time of mounting the multilayer ceramic capacitor on the printed circuit board and thus reducing the size of a product (mounting substrate).

In addition, four independent multilayer ceramic capacitors need to be respectively picked up and mounted on the printed circuit board 210 in order to achieve similar mounting for the array type multilayer ceramic capacitor 100 having four different internal electrode laminated parts having different numbers of laminations. However, the present embodiment allows a single work of pick-up, thereby reducing the process and improving productivity.

As set forth above, according to the present invention, the mounting area occupied when a plurality of array type multilayer ceramic electronic components having various electric characteristics can be reduced by configuring a plurality of internal electrode laminated parts with different numbers of laminations in one ceramic element, thereby reducing the size of a product (mounting substrate).

Further, the number of occurrences of pick-up of the multilayer ceramic electronic components is decreased at the time of performing a mounting process, thereby improving product productivity.

While the present invention has been shown and described in connection with the embodiments, it will be apparent to those skilled in the art that modifications and variations can be made without departing from the spirit and scope of the invention as defined by the appended claims

What is claimed is:

1. An array type multilayer ceramic electronic component, comprising:
a ceramic element having a plurality of dielectric layers laminated therein;
first and second external electrodes spaced apart from each other in a length direction on one surface and the other surface opposing the one surface of the ceramic element; and
a plurality of internal electrode laminated parts including a plurality of first and second internal electrodes opposing each other within the ceramic element and connected to the first and second external electrodes,
wherein a portion of the internal electrode laminated parts is different from other internal electrode laminated parts thereof in terms of the number of laminations of the first and second internal electrodes.

2. The array type multilayer ceramic electronic component of claim 1, wherein all of the internal electrode laminated parts are different in terms of the number of laminations of the first and second internal electrodes.

3. The array type multilayer ceramic electronic component of claim 1, wherein the first and second external electrodes are extended in a direction in which the first and second internal electrodes are laminated.

4. The array type multilayer ceramic electronic component of claim 1, wherein the first and second external electrodes are extended to portions of upper and lower surfaces of the ceramic element.

5. The array type multilayer ceramic electronic component of claim 1, wherein the first and second external electrodes are disposed to oppose each other.

6. The array type multilayer ceramic electronic component of claim 1, wherein the first and second internal electrodes are led out in opposite directions such that the first and second internal electrodes are alternately connected to the first and second external electrodes.

7. The array type multilayer ceramic electronic component of claim 1, wherein the first and second internal electrodes includes capacitance forming portions overlapped with each other with the dielectric layers interposed therebetween to thereby contribute to capacitance formation, and lead out portions extended from the capacitance forming portions to the one surface or the other surface of the ceramic element and respectively connected to the first and second external electrodes.

8. Amounting structure of a circuit board having an array type multilayer ceramic electronic component mounted thereon, the mounting structure comprising:
a printed circuit board having a plurality of first and second electrode pads spaced apart from each other in a length direction on an upper surface thereof; and
an array type multilayer ceramic capacitor mounted on the printed circuit board,
the array type multilayer ceramic electronic component including: a ceramic element having a plurality of dielectric layers laminated therein; first and second external electrodes spaced apart from each other in a length direction on one surface and the other surface opposing the one surface of the ceramic element and connected to the plurality of first and second electrode pads, respectively; and a plurality of internal electrode laminated parts including a plurality of first and second internal electrodes opposing each other within the ceramic element and connected to the first and second external electrodes, wherein a portion of the internal electrode laminated parts is different from other internal electrode laminated parts thereof in terms of the number of laminations of the first and second internal electrodes.

9. A method of manufacturing an array type multilayer ceramic electronic component, the method comprising:
forming a plurality of first and second internal electrodes on ceramic sheets, the first and second internal electrodes being exposed through one surface or the other surface opposing the one surface of the ceramic sheets and spaced apart from each other in a length direction;
forming a laminate having a plurality of internal electrode laminated parts spaced apart from each other in the length direction by laminating the plurality of ceramic sheets on which the plurality of first and second internal electrodes are formed;
forming a ceramic element by firing the laminate; and
forming a plurality of first and second external electrodes to be spaced apart from each other in the length direction on both surfaces of the ceramic element, in order to cover exposed portions of the respective internal electrode laminated parts,
wherein in the forming of the internal electrodes, the number of internal electrodes spaced apart from each other in the length direction on the ceramic sheets disposed above and below is controlled such that the respective internal electrode laminated parts have different numbers of laminations of internal electrodes.

10. The method of claim 9, wherein in the forming of the external electrodes, the first and second first and second external electrodes are extended in a direction in which the first and second internal electrodes are laminated on the both surfaces of the ceramic element.

11. The method of claim 9, wherein in the forming of the external electrodes, the first and second external electrodes are extended to portions of upper and lower surfaces of the ceramic element.

12. The method of claim 9, wherein in the forming of the external electrodes, the first and second external electrodes are disposed to oppose each other on the both surfaces of the ceramic element.

13. The method of claim 9, wherein in the forming of the internal electrodes, the first and second internal electrodes are led out in opposite directions such that the first and second internal electrodes are alternately connected to the first and second external electrodes.
